(19) United States
(12) Patent Application Publication
(10) Pub. No.: US 2020/0032994 A1
(43) Pub. Date: Jan. 30, 2020

(54) LIGHT SOURCE DEVICE

(71) Applicant: SHIMADZU CORPORATION, Kyoto (JP)

(72) Inventor: Zeno YONEZAWA, Kyoto (JP)

(73) Assignee: SHIMADZU CORPORATION, Kyoto (JP)

(21) Appl. No.: 16/522,609

(22) Filed: Jul. 25, 2019

(30) Foreign Application Priority Data
Jul. 27, 2018 (JP) 2018-141339

(51) Int. Cl. F21V 29/89; F21V 3/02

(52) U.S. Cl. CPC F21V 29/89; F21V 3/02

(57) ABSTRACT

A light source device capable of inhibiting an increase in the temperature of a lamp housing due to light emitted from a lamp is provided. A rectangular parallelepiped lamp housing (2) which is a hexahedron is configured such that a concavo-convex member (31) is disposed on all of six inner surfaces thereof and a concavo-convex member (33) is disposed on six outer surfaces thereof. The concavo-convex member (31) is called a heat sink or the like and is formed by processing aluminum and then performing black alumite treatment on the surface thereof. A convex portion formed in the concavo-convex member (31) extends in a direction perpendicular to a longitudinal direction of a xenon lamp (1).

### CROSS REFERENCE TO RELATED APPLICATION

The disclosure claims priority under 35 U.S.C. § 119 to Japanese Patent Application No. 2018-141339 filed on Jul. 27, 2018. The entire content of which is incorporated herein by reference.

### BACKGROUND

### Technical Field

The present disclosure relates to a light source device that includes a lamp and a lamp housing surrounding the lamp and including an extraction port for light emitted from the lamp.

### Description of Related Art

In such a light source device, for example, a xenon (Xe) lamp is used, and a configuration in which the lamp is covered by a lamp housing having a light tight structure is adopted in order to prevent light from the lamp from leaking to the outside. On the other hand, in such a light source device, the temperature of the lamp housing itself increases due to heat generated from the lamp as the lamp is continuously turned on. For this reason, in such a light source device, a cooling mechanism that cools the lamp housing using an air-cooling mechanism is attached (see Patent Document 1).

### PATENT DOCUMENTS

[Patent Document 1] Japanese Patent Laid-Open No. 2007-140160

In this manner, in a light source device of the related art, a lamp housing is cooled through air cooling, but an increase in the temperature of the lamp housing becomes prominent due to reflection of light inside the lamp housing when the lamp housing is configured to be compact. In addition, a lamp itself is also heated with an increase in the temperature of the lamp housing. In a case where the lamp is heated, a gap may be generated between a glass bulb and a base due to a difference in linear expansion coefficient between a glass bulb portion and a base portion constituting the lamp, which may lead to a problem such as leakage of an internal gas (xenon gas in a case of a xenon lamp).

In addition, it is also conceivable that an inner wall be colored in black in order to inhibit the reflection of light from the inner wall of the lamp housing. However, in a case where the light source device is used for a long period of time, discoloration occurs, which results in a reduction in a reflection inhibition effect.

### SUMMARY

The disclosure provides a light source device capable of inhibiting an increase in the temperature of a lamp housing due to light emitted from a lamp.

According to an embodiment, there is provided a light source device including a lamp and a lamp housing which surrounds the lamp and includes an extraction port for light emitted from the lamp, in which a concavo-convex member in which a plurality of convex portions and concave portions are consecutively formed and tip ends of the convex portions are directed to a direction of the lamp is disposed on an inner surface of the lamp housing.

In the light source device according to an embodiment, the convex portions may extend in a direction intersecting a longitudinal direction of the lamp.

In the light source device according to an embodiment, a relation of H>2D may be established when a height of the convex portion is set to be H and an interval between the convex portions is set to be D.

In the light source device according to an embodiment, the concavo-convex member may include a material formed by performing black alumite treatment on aluminum.

According to the disclosure, it is possible to inhibit an increase in the temperature of a lamp housing due to light emitted from a lamp by an operation of a concavo-convex member.

According to the disclosure, it is possible to more effectively inhibit an increase in the temperature of a lamp housing by preventing light from being reflected from the surface of a concavo-convex member.

### BRIEF DESCRIPTION OF THE DRAWINGS

FIG. 1 is a diagram showing an outline of a light source device according to the disclosure.

FIG. 2 is a diagram when a concavo-convex member 31 is seen in a direction of an arrow A in FIG. 1.

FIG. 3 is a diagram when a concavo-convex member 33 is seen in a direction of an arrow B in FIG. 1.

FIG. 4 is a partially enlarged view of the concavo-convex member 31.

### DESCRIPTION OF THE EMBODIMENTS

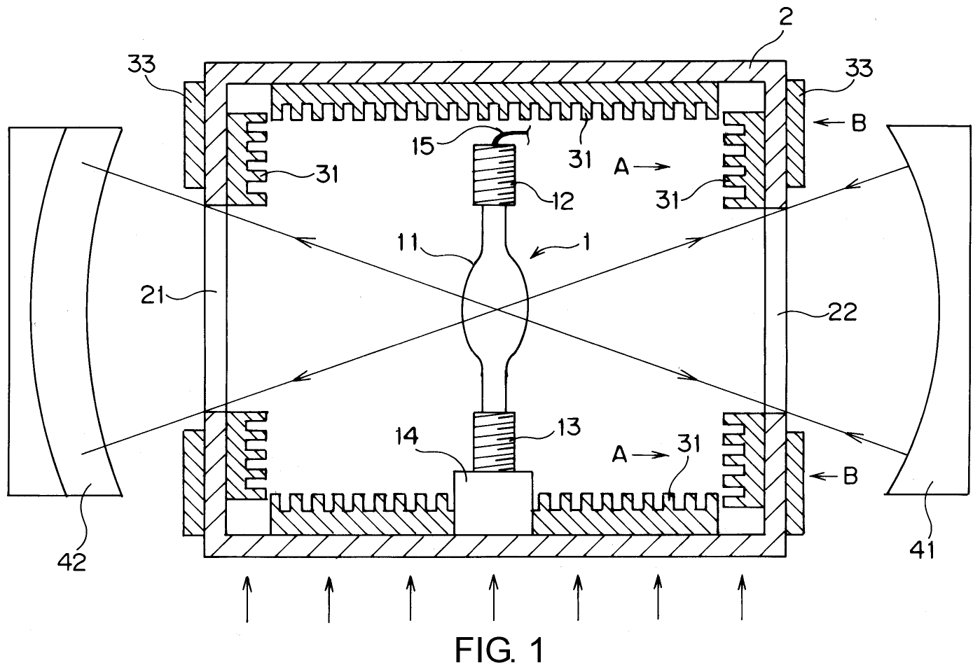

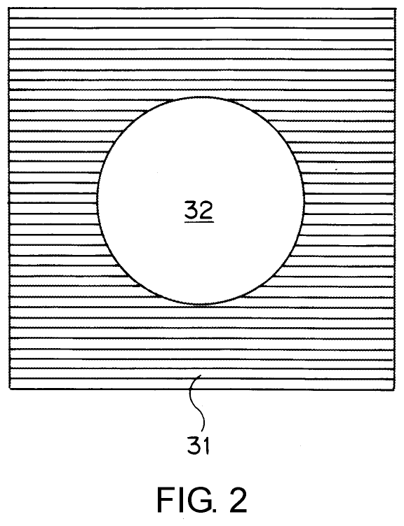

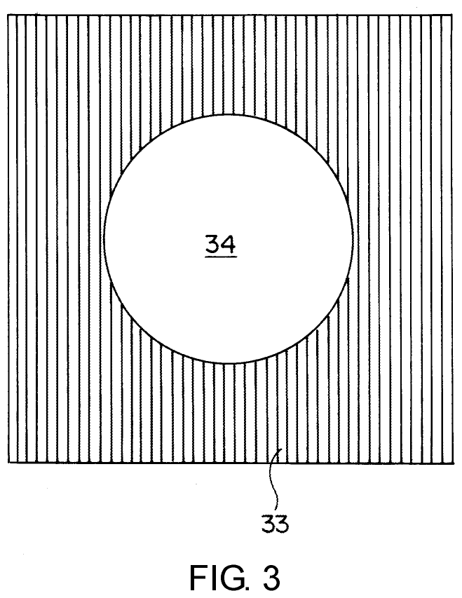

Hereinafter, an embodiment of the disclosure will be described with reference to the accompanying drawings. FIG. 1 is a diagram showing an outline of a light source device according to the disclosure. FIG. 2 is a diagram when a concavo-convex member 31 is seen in a direction of an arrow A in FIG. 1. FIG. 3 is a diagram when a concavo-convex member 33 is seen in a direction of an arrow B in FIG. 1.

The light source device is used in an analysis device such as a spectrophotometer. Light emitted from the light source device is made to have a predetermined wavelength by a spectroscope, is made to pass through a filter to be monochromatic light, and is then emitted to an analysis target in the analysis device such as a spectrophotometer.

The light source device includes a xenon lamp 1, a rectangular parallelepiped lamp housing 2 surrounding the xenon lamp 1, and a pair of concave mirrors 41 and 42.

The xenon lamp 1 includes a glass bulb 11 filled with xenon gas and bases 12 and 13 disposed at both ends of the glass bulb 11, and is disposed inside the lamp housing 2 with its longitudinal direction as a vertical direction. The base 13 disposed below the xenon lamp 1 is supported by a metal block 14 disposed at the bottom of the lamp housing 2 and is electrically connected to a power supply. In addition, the base 12 disposed above the xenon lamp 1 is electrically connected to a power supply through a lead wire 15.

The rectangular parallelepiped lamp housing 2 which is a hexahedron is configured such that a concavo-convex member 31 is disposed on all of six inner surfaces thereof and a concavo-convex member 33 is disposed on six outer surfaces thereof. In the lamp housing 2, a pair of light extraction ports 21 and 22 are formed on surfaces facing each other. Meanwhile, as shown in FIG. 2, an opening 32 corresponding to the light extraction ports 21 and 22 in the lamp housing 2 is formed in the concavo-convex members 31 disposed having the light extraction ports 21 and 22 formed therein among the six concavo-convex members 31. In addition, as shown in FIG. 3, an opening 34 corresponding to the light extraction ports 21 and 22 in the lamp housing 2 is also formed in the concavo-convex members 33 disposed on the outer surface of the lamp housing 2.

Light emitted from the xenon lamp 1 and emitted to the outside from the light extraction port 21 reaches a concave mirror 42. In addition, light emitted from the xenon lamp 1 and emitted from the light extraction port 22 is reflected by the concave mirror 41 and then reaches the concave mirror 42 through the light extraction port 21. Since the concave mirror 42 is disposed so as to be inclined with respect to an optical axis of light emitted from the lamp housing 2, light reaching the concave mirror 42 is deflected in a direction displaced at 90 degrees from the optical axis of light emitted from the lamp housing 2 (a direction perpendicular to the paper in FIG. 1).

Meanwhile, rising air is supplied to the lamp housing 2 by a fan not shown in the drawing as shown by an arrow in FIG. 1. This rising air rises along the concavo-convex member 33 and cools the lamp housing 2 through the concavo-convex member 33.

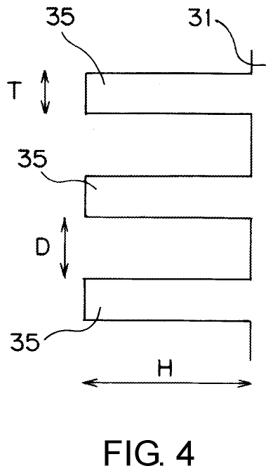

FIG. 4 is a partially enlarged view of the concavo-convex member 31. Meanwhile, the concavo-convex member 33 also has the same configuration as the concavo-convex member 31.

The concavo-convex member 31 is called a heat sink or the like and is formed by processing aluminum and then performing black alumite treatment on the surface thereof. Meanwhile, the alumite treatment (anodization treatment) is a surface treatment for performing electrolytic treatment on aluminum with an anode to artificially form an oxide film (aluminum oxide), and the black alumite treatment is treatment for coloring the oxide film with a black dye after the alumite treatment.

Meanwhile, in addition to aluminum, other metals having a high thermal conductivity can be used as a material of the concavo-convex member 31.

A convex portion 35 formed in the concavo-convex member 31 extends in a direction perpendicular to the longitudinal direction (a vertical direction in FIG. 1) of the xenon lamp 1. As shown in FIG. 4, when a height of the convex portion 35 is set to be H, a thickness is set to be T, and an interval is set to be D, for example, the height H is 5 millimeters, the thickness T is 0.4 millimeters, and the interval D is 2 millimeters.

In this case, it is preferable that the height H be twice or more the interval D, that is, H>2D, and the interval D be three times or more the thickness T, that is, D>3T. With such a configuration, it is possible to prevent light incident on a region between the convex portions 35 from being emitted from the region between the convex portions 35 again by reflection. Meanwhile, it is preferable that the thickness T have a smaller value in order to prevent the reflection of light in a tip end region. However, when the thickness T is made excessively small, it is difficult to process irregularities, and there is a problem in that the convex portions 35 are easily damaged.

In a case where light emitted from the xenon lamp 1 is incident on the concavo-convex member 31, the majority of the light is captured (trapped) in a region between the convex portions 35 and is converted into thermal energy. For this reason, the reflection of light inside the lamp housing 2 is inhibited, and it is possible to inhibit an increase in the temperature of the xenon lamp 1 and the lamp housing 2.

In the light source device having the above-described configuration, light emitted from the xenon lamp 1 and emitted to the outside from the light extraction ports 21 and 22 is deflected in a predetermined direction by the concave mirrors 41 and 42. On the other hand, light other than the light emitted to the outside from the light extraction ports 21 and 22 is captured by the concavo-convex member 31 and is converted into thermal energy. Thereby, the temperature of the concavo-convex member 31 rises, but the thermal energy is transmitted to the concavo-convex member 33 disposed outside the lamp housing 2 through the lamp housing 2. In addition, the concavo-convex member 33 is cooled by rising air directed to the lamp housing 2. For this reason, it is possible to inhibit an increase in the temperature of the lamp housing 2.

Meanwhile, in the above-described embodiment, the xenon lamp 1 is used as a lamp, but other lamps such as a halogen lamp may be used.

Further, in the above-described embodiment, as shown in FIGS. 1 and 2, the concavo-convex member 31 in which the convex portions 35 are densely disposed has been described, but a concavo-convex member in which the convex portions 35 are disposed sparsely may be used in a peripheral portion.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

### REFERENCE SIGNS LIST

1 Xenon lamp
2 Lamp housing
11 Glass bulb
12 Base
13 Base
21 Light extraction port
22 Light extraction port
31 Concavo-convex member
32 Opening
33 Concavo-convex member
34 Opening
35 Convex portion
41 Concave mirror
42 Concave mirror

What is claimed is:

1. A light source device comprising:
a lamp; and
a lamp housing which surrounds the lamp and includes an extraction port for light emitted from the lamp,
wherein a concavo-convex member in which a plurality of convex portions and a plurality of concave portions are consecutively formed and tip ends of the plurality of convex portions are directed to a direction of the lamp is disposed on an inner surface of the lamp housing.

2. The light source device according to claim 1, wherein the plurality of convex portions extend in a direction intersecting a longitudinal direction of the lamp.

3. The light source device according to claim 2, wherein a relation of H>2D is established when a height of the plurality of convex portion is set to be H and an interval between the plurality of convex portions is set to be D.

4. The light source device according to claim 1, wherein the concavo-convex member includes a material formed by performing black alumite treatment on aluminum.

5. The light source device according to claim 2, wherein the concavo-convex member includes a material formed by performing black alumite treatment on aluminum.

6. The light source device according to claim 3, wherein the concavo-convex member includes a material formed by performing black alumite treatment on aluminum.
